(19) United States
(12) Patent Application Publication
(10) Pub. No.: US 2018/0306156 A1
(43) Pub. Date: Oct. 25, 2018

(54) Valve Assembly For An Injection Valve

(71) Applicant: Continental Automotive GmbH, Hannover (DE)

(72) Inventors: Christoph Hamann, Thalmassing (DE); Matteo Soriani, Livorno (IT)

(73) Assignee: Continental Automotive GmbH, Hannover (DE)

(21) Appl. No.: 15/766,280

(22) PCT Filed: Aug. 29, 2016
(86) PCT No.: PCT/EP2016/070281

§ 371 Date: Apr. 5, 2018

(30) Foreign Application Priority Data
Oct. 8, 2015 (EP) 15188873.2

(51) Int. Cl. F02M 61/20; F02M 61/10; F02M 61/16

(52) U.S. Cl. CPC F02M 61/205; F02M 61/10; F02M 2200/8061; F02M 2200/505; F02M 61/168

(57) ABSTRACT

The present disclosure relates to fluid injection valves. Various embodiments may include a valve assembly for a fluid injection valve and a fluid injection valve including: a valve body with a longitudinal axis; a valve needle; and a preloaded calibration spring for biasing the valve needle. The calibration spring is preloaded by press-fitting a fixing region of the calibration spring with a fixing element, wherein the fixing region of the calibration spring extends from the upper part. The calibration spring comprises an adjustment cap arranged around the upper part of the spring element and press-fitted with the fixing element. A circumferential side wall of the adjustment cap provides the fixing region.

### CROSS-REFERENCE TO RELATED APPLICATIONS

This application is a U.S. National Stage Application of International Application No. PCT/EP2016/070281 filed Aug. 29, 2016, which designates the United States of America, and claims priority to EP Application No. 15188873.2 filed Oct. 8, 2015, the contents of which are hereby incorporated by reference in their entirety.

### TECHNICAL FIELD

The present disclosure relates to fluid injection valves. Various embodiments may include a valve assembly for a fluid injection valve and a fluid injection valve.

### BACKGROUND

A typical valve assembly for a fluid injection valve comprises a valve body with a cavity having a fluid inlet portion and a fluid outlet portion and a valve needle axially moveable in the cavity. The valve needle prevents a fluid flow through the fluid outlet portion in a closing position and releases the fluid flow through the fluid outlet portion in further positions. The valve needle may be actuated by an electromagnetic actuator unit.

In many examples, the valve needle is biased towards a closing position by a preloaded calibration spring. The calibration spring can be preloaded by press-fitting a filter tube or fuel tube into the housing, the pole piece, or another element of the injection valve as disclosed in U.S. Pat. No. 6,997,404 B2. The filter tube or fuel tube is located on top of the spring. This solution, however, adds to the length of the injector.

### SUMMARY

The teachings of the present disclosure may provide a space-saving valve assembly for an injection valve and an injection valve with such a valve assembly. For example, a valve assembly (3) for an injection valve (1) may include: a valve body (5) having a longitudinal axis (L) comprising a cavity (7) with a fluid inlet portion (9) and a fluid outlet portion (11); and a valve needle (13) axially moveable in the cavity (7), the valve needle (13) preventing a fluid flow through the fluid outlet portion (11) in a closing position and releasing the fluid flow through the fluid outlet (11) portion in further positions.

In some embodiments, the valve assembly (3) may further include a preloaded calibration spring (15) for biasing the valve needle (13), the calibration spring (15) comprising an axially compliant spring element (27). The spring element (27) may have a lower part (29) which is allocated near one end of the needle (13) and an upper part (31) which is allocated at a distance from the needle (13), wherein the calibration spring (15) is preloaded by press-fitting a fixing region (35) of the calibration spring (15) with a fixing element of the valve assembly (3). The the fixing region (35) extends laterally around the upper part (31) of the spring element (27) and/or from the upper part (31) of the spring element (27) downwards towards the lower part (29). In some embodiments, the axially compliant spring element (27) is a coil spring. The calibration spring (15) comprises an adjustment cap (33) which is arranged around the upper part (31) of the spring element (27) and press-fitted with the fixing element, a circumferential side wall (37) of the adjustment cap (33) constituting the fixing region (35), and the adjustment cap (33) comprises an end cover (39) with a central opening (41).

In some embodiments, the cylindrical side wall (37) encloses a plurality of turns of the coil spring which represent the upper part (31).

In some embodiments, the central opening (41) has a diameter of 0.5 mm to 1 mm.

In some embodiments, the diameter of the central opening (41) is preferably 25% or less of the outer diameter of the end cover (39).

In some embodiments, the adjustment cap (33) comprises steel and/or copper alloy.

In some embodiments, the fixing element is a pole piece (23) of the valve assembly (3).

As another example, a fluid injection valve (10) may include a valve assembly (3) as described above.

As another example, a method for assembling a fluid injection valve (1) may include: fitting the spring element (27) with the adjustment cap (33) to produce the calibration spring (15); inserting the spring element (27) and the adjustment cap (33) into the cavity (7), press-fitting the adjustment cap (33) with the fixing element of the valve assembly (3), wherein a preload of the calibration spring (27) is adjusted by choosing the depth of the insertion of the adjustment cap (33) in the fixing element with respect to the longitudinal axis (L).

### BRIEF DESCRIPTION OF THE DRAWINGS

Further advantages, embodiments, and developments of the valve assembly for an injection valve, the fluid injection valve, and the method for manufacturing a fluid injection valve will become apparent from the embodiments described below in association with schematic figures.

FIG. 1 shows a longitudinal section view of an injection valve according to teachings of the present disclosure;

FIG. 2 shows a detail of FIG. 1; and

FIG. 3 shows an adjustment cap of the injection valve according to FIG. 1.

Elements of the same design and function that appear in different illustrations are identified by the same reference character.

### DETAILED DESCRIPTION

In some embodiments, a valve assembly for an injection valve comprises a valve body which has a longitudinal axis and comprises a cavity with a fluid inlet portion and a fluid outlet portion. The cavity extends along the longitudinal axis from the fluid inlet portion to the fluid outlet portion. The valve assembly comprises a valve needle. The valve needle is axially moveable in the cavity—it is received in the cavity and axially displaceable in the cavity relative to the valve body. The valve needle is operable to prevent a fluid flow through the fluid outlet portion in a closing position and to release the fluid flow through the fluid outlet portion in further positions.

The valve assembly further comprises a preloaded calibration spring for biasing the valve needle. In some embodiments, the calibration spring is operable to bias the valve needle axially towards the closing position. The calibration spring comprises an axially compliant spring element. In some embodiments, the axially compliant spring element comprises a coil spring. The turns of the coil spring may be wound around the longitudinal axis.

In some embodiments, the spring element comprises a lower part which is allocated near one end of the needle and an upper part which is allocated at a distance from the needle. In some embodiments, the lower part is in contact with an axial end of the needle remote from the fluid outlet portion. The lower part and the upper part may be opposite axial end regions of the spring element.

In some embodiments, the calibration spring is preloaded by press-fitting a fixing region of the calibration spring with a fixing element of the valve assembly. In some embodiments, the fixing region extends laterally around the upper part of the calibration spring and/or downwards from the upper part of the calibration spring. To put it differently, the calibration spring comprises a fixing region which is shifted onto or into the fixing element of the valve assembly, such that a press-fit connection is established between the fixing region of the calibration spring and the fixing element. The fixing element may be positionally fixed relative to the valve body.

Hence, in some embodiments, the fixing region does not extend upwards from the calibration spring but only around the upper part or some distance downwards from the upper part—i.e. some distance towards its lower part—of the spring element. By this, the clamping area which sets the axial position of the upper part of the spring element is moved from above the spring element to a region which, in some embodiments, axially overlaps the spring element.

In some embodiments, the space above the spring is not required for the preloading of the spring. This space can be used differently, particularly for the reduction of pressure waves from the rail. Alternatively, the overall length of the injector can be reduced.

In some embodiments, the press-fit connection is established between the spring element itself and the fixing element, without an additional fuel tube, filter tube, or the like which has to be assembled separately from the spring element. Therefore, assembling of the valve assembly is particularly simple.

In some embodiments, the fixing region may be formed by the spring element itself, e.g. as an external surface of the uppermost turn of the coil spring. In this case, the calibration spring is preloaded by press-fitting the uppermost turn of the spring element with a fixing element of the valve assembly.

In some embodiments, the calibration spring comprises an adjustment cap which is arranged around the upper part of the spring element and press-fitted with the fixing element, a circumferential side wall of the adjustment cap constituting the fixing region. The circumferential side wall may be a cylindrical side wall.

In this case, the side wall of the adjustment cap fixed to the spring constitutes the fixing region. The fixing region can be much larger than the area offered by the uppermost coil of the spring, and therefore the press-fit can be particularly tight. In addition, the adjustment cap may enable particularly good axial guidance and force transfer from a tool during the press-fit operation.

In some embodiments, the cylindrical side wall encloses a plurality of turns of the spring element which plurality of turns represents the upper part. In these embodiments, the side wall reaches down the distance of several turns and provides a large area for the press-fit.

In some embodiments, the spring element can move relative to the adjustment cap. For example, the upper part is shifted into the adjustment cap and the spring element projects from the adjustment cap towards the lower part. The upper part may be in form-fit connection with the cap to block movement of the upper part relative to the cap in direction away from the valve needle. In some embodiments, the cap does not interact with the spring element to block movement of the upper part towards the valve needle. In some embodiments, the upper part is rigidly fixed to the cap. In some embodiments, the cap is shaped and arranged so that it axially guides central portion of the spring element, the central portion being axially positioned between the upper part and the lower part. For example, the cap has a constriction at its end facing towards the valve needle for axially guiding the central portion.

In some embodiments, the adjustment cap comprises an end cover with a central opening. The end cover may be in form-fit connection with the upper part of the spring element to block movement of the upper part relative to the cap in direction away from the valve needle.

The opening allows fuel to pass through the adjustment cap which can be otherwise closed. In some embodiments, a dampening effect on pressure waves in the fuel is created. It has been found that the dampening effect and the passage of fuel through the cap are both satisfactory if the central opening has a diameter of 0.5 millimeters to 1 millimeters, more particularly of 0.7 millimeters to 0.9 millimeters. The end cover may have a diameter of 3 mm or more, preferably of 4 mm or more, and/or of 20 mm or less, preferably of 15 mm or less, for example of 10 mm or less. To put it differently, the diameter of the central opening may be 25% or less, or 20% or less, of the outer diameter of the end cover, so that a satisfactory dampening effect is achieved. In some embodiments, it has a value of 5% or more, in particular of 10% or more, of the diameter of the end cover to achieve a satisfactory hydraulic diameter for the fluid flowing through the adjustment cap from the fluid inlet portion to the fluid outlet portion. In some embodiments, the adjustment cap comprises steel, spring steel, and/or a copper alloy. These materials have the necessary corrosion resistance and provide the suitable mechanical properties for a tight press-fit. The adjustment cap could be formed in one piece with the calibration spring.

In some embodiments, the fixing element may comprise a pole piece of the valve assembly. The pole piece may be a stationary core of an electromagnetic actuator assembly, the actuator assembly being operable to displace the valve needle away from the closing position against the bias of the calibration spring. The pole piece may be in one piece with the valve body or fixed to the valve body, e.g. inside the cavity. The pole piece may provide a rigid element suitable to receive the adjustment cap. The pole piece typically has a central opening receiving the calibration spring. Fluid may flow from the fluid inlet portion to the fluid outlet portion through the central opening of the pole piece. Into this central opening the spring with the adjustment cap may be pressed.

Some embodiments may include a method for assembling the described fluid injection valve comprising fitting the spring element with the adjustment cap—in particular shifting the spring element into the adjustment cap, inserting the spring element and the adjustment cap into the cavity, and press-fitting the adjustment cap with the fixing element of the valve assembly, wherein a preload of the calibration spring is adjusted by choosing the depth of the insertion of the adjustment cap in the fixing element. The steps of fitting the calibration spring with the adjustment cap and inserting the spring and the adjustment cap into the cavity may be carried out in either order, unless the spring element is rigidly fixed to the cap before inserting into the cavity. If the calibration spring is fitted with the adjustment cap before being inserted into the cavity, only one component has to be handled during assembly.

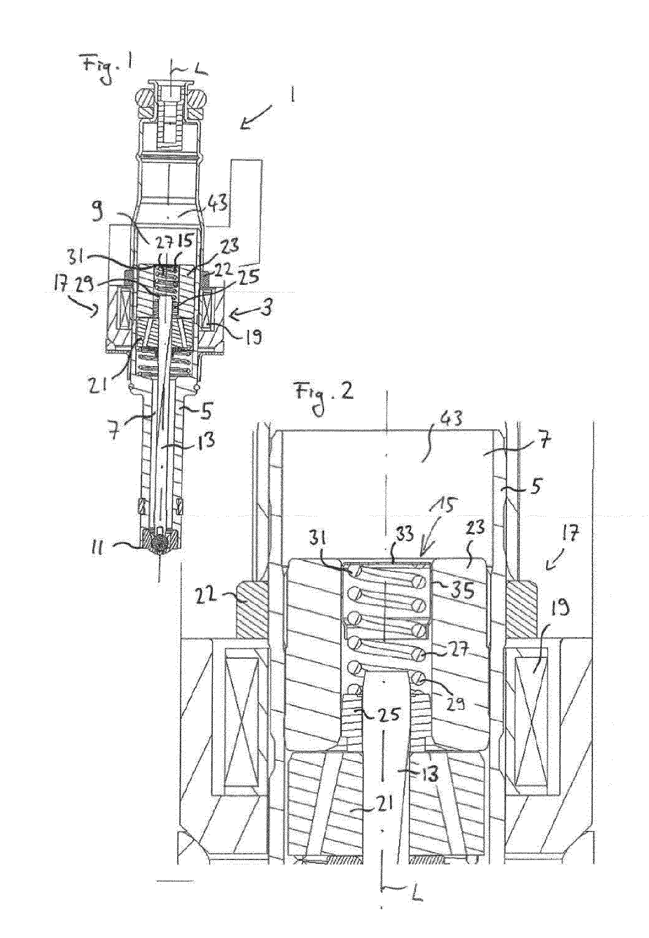

FIG. 1 shows a fluid injection valve 1 according to the teachings of the present disclosure in a schematic longitudinal section view. A detail of FIG. 1 is shown enlarged in FIG. 2. The fluid injection valve 1 shown in FIGS. 1 and 2 is in particular suitable for dosing fuel to an internal combustion engine. However, the valve shown could be used in other types of injection valves, too.

The injection valve 1 comprises a valve assembly 3. The valve assembly 3 comprises a valve body 5 with a central longitudinal axis L. The valve body 5 comprises a cavity 7. The cavity 7 has a fluid outlet portion 11. The fluid outlet portion 11 hydraulically communicates via the cavity 7 with a fluid inlet portion 9 of the cavity 7. The fluid inlet portion 9 and the fluid outlet portion 11 are positioned at opposite axial ends of the valve body 5.

The cavity 7 takes in a valve needle 13. The valve needle 13 comprises a needle shaft, a sealing ball welded to the tip of the needle shaft, and a retainer 25. The retainer 25 is positioned in an axial end region of the valve needle 13 remote from the sealing ball. It is fixed to the needle shaft and circumferentially surrounds the needle shaft. In some embodiments, the retainer 25 is in one piece with the needle shaft and represented by a collar of the needle shaft.

The injection valve 1 comprises an electromagnetic actuator unit 17 for moving the valve needle 13. The actuator unit 17 comprises a solenoid 19, an armature 21, a yoke 22, and a pole piece 23. The armature 21 moves axially in the cavity 7. The armature 21 may be separate from the valve needle 13 and move axially relative both to the valve needle 13 and to the valve body 5. The armature 21 is operable to engage in form-fit connection with the retainer 25 for axially moving the valve needle 13.

A calibration spring 15 is arranged in the cavity 7 at the end of the valve needle 13 facing the fluid inlet portion 9. The calibration spring 15 comprises an axially compliant spring element 27 and an adjustment cap 33.

The spring element 27 may comprise a coil spring and has a multitude of turns which are wound around the longitudinal axis L. A lower part 29 of the spring element 27 is supported by the retainer 25. It could additionally or alternatively be supported by the needle shaft.

An upper part 31 of the spring element 27 is supported by the adjustment cap 33, which is press-fitted into a central opening the pole piece 23. The exterior surface of the cylindrical side wall 37 of the adjustment cap 33 is in contact with the interior wall of the pole piece 23. The region of contact between the adjustment cap 33 and the pole piece 23 is the fixing region 35.

During the manufacturing process of the injection valve 1, the adjustment cap 33 can be moved axially into the valve body 5 until it is axially overlapping a central opening of the pole piece to preload the spring element 27 in a desired manner. By this the calibration spring 15 exerts a force on the valve needle 13 towards the closing position, i.e. in the present embodiment of an inward opening injection valve towards the fluid outlet portion 11. In the closing position of the valve needle 13, a fluid flow through the fluid outlet portion 11 is prevented.

To move the valve needle 13 to an opening position, the solenoid 19 is energized and the armature 21 moves upwards, taking with it the valve needle 13 by means of the retainer 25 against the bias of the calibration spring 15. The fluid outlet portion 11 is thus opened.

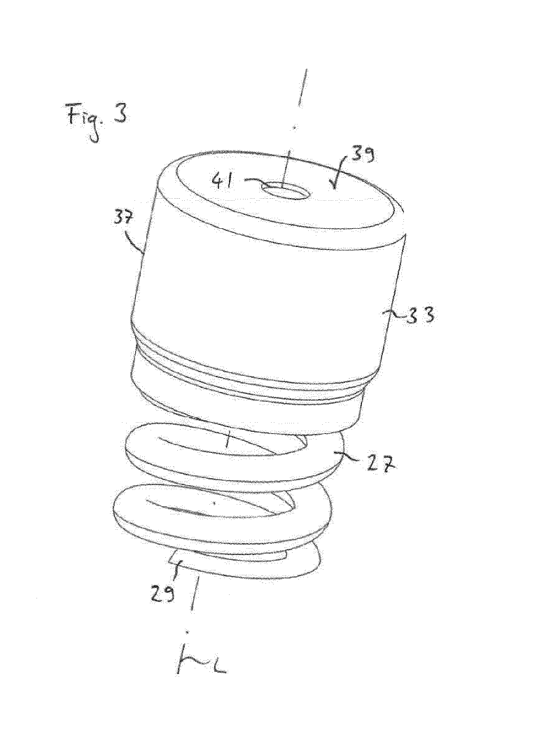

FIG. 3 shows details of the adjustment cap 33. It has a cylindrical circumferential side wall 37 and an end cover 39. The end cover 39 substantially closes the cap 33 at one axial end of the circumferential side wall 37. An outer circumferential edge of the end cover 39 merges with the side wall 37. The side wall 37 encloses the upper part 31 of the spring element 27. The end cover 39 comprises a central opening 41 which forms a passage for the fluid. The central opening 41 has a diameter of 0.7 to 0.9 mm—corresponding to less than 20% of the diameter of the end cover 39—and has therefore a dampening effect on pressure waves coming from the fluid inlet portion 9.

The adjustment cap 33, in particular the diameter of its cylindrical side wall 37, is dimensioned such that it fits tightly in the central opening of the pole piece 23. The adjustment cap 33 is made of steel, particularly spring steel, or a copper alloy.

As can be seen in FIGS. 1 and 2, there is a space 43 above the adjustment cap 33, where according to the state of the art there would be an adjustment tube preloading the calibration spring 27. The adjustment cap 33 does to reach above the pole piece 23. Therefore, the space 43 above the pole piece 23 can be used to dissipate pressure waves. In another embodiment, the injection valve 1 could be made shorter.

What is claimed is:

1-8. (canceled)

9. A valve assembly for an injection valve, the assembly comprising:
a valve body with a longitudinal axis, the valve body comprising a cavity with a fluid inlet portion and a fluid outlet portion;
a valve needle axially moveable in the cavity, the valve needle preventing a fluid flow through the fluid outlet portion in a closed position and releasing the fluid flow through the fluid outlet portion in further positions;
a preloaded calibration spring for biasing the valve needle, the calibration spring comprising an axially compliant spring element;
the spring element having a lower part allocated near one end of the needle and an upper part allocated at a distance from the needle;
wherein the calibration spring is preloaded by press-fitting a fixing region of the calibration spring with a fixing element;
wherein the fixing region of the calibration spring extends laterally around the upper part of the spring element and/or from the upper part of the spring element downwards towards the lower part;
wherein the calibration spring comprises an adjustment cap arranged around the upper part of the spring element and press-fitted with the fixing element; and
a circumferential side wall of the adjustment cap provides the fixing region.

10. A valve assembly according to claim 9, wherein the central opening has a diameter of 0.5 mm to 1 mm.

11. A valve assembly according to claim 9, wherein the diameter of the cenral opening is preferably 25% or less of the outer diameter of the end cover.

12. A valve assembly according to claim 9, wherein the circumferential side wall encloses a plurality of turns of the coil spring of the upper part.

13. A valve assembly according to claim 11, wherein the central opening has a diameter of 0.5 mm to 1 mm.

14. A valve assembly according to claim 9, wherein the diameter of the central opening measures 25% or less of an outer diameter of the end cover.

15. A valve assembly according to claim 9, wherein the adjustment cap comprises steel and/or a copper alloy.

16. A valve assembly according to claim 9, wherein the fixing element comprises a pole piece of the valve assembly.

17. A fluid injection valve comprising:
a valve body with a longitudinal axis, the valve body comprising a cavity with a fluid inlet portion and a fluid outlet portion;
a valve needle axially moveable in the cavity, the valve needle preventing a fluid flow through the fluid outlet portion in a closed position and releasing the fluid flow through the fluid outlet portion in further positions;
a preloaded calibration spring for biasing the valve needle, the calibration spring comprising an axially compliant spring element;
the spring element having a lower part allocated near one end of the needle and an upper part allocated at a distance from the needle;
wherein the calibration spring is preloaded by press-fitting a fixing region of the calibration spring with a fixing element;
wherein the fixing region of the calibration spring extends laterally around the upper part of the spring element and/or from the upper part of the spring element downwards towards the lower part;
wherein the calibration spring comprises an adjustment cap arranged around the upper part of the spring element and press-fitted with the fixing element; and
a circumferential side wall of the adjustment cap provides the fixing region.

18. A method for assembling a fluid injection valve, the method comprising:
fitting a spring element with an adjustment cap to produce a calibration spring;
inserting the spring element and the adjustment cap into a cavity of a valve body; and
press-fitting the adjustment cap with a fixing element of the valve assembly;
wherein a preload of the calibration spring is adjusted by choosing a depth of insertion of the adjustment cap in the fixing element with respect to a longitudinal axis of the valve body.
